(19) United States
(12) Patent Application Publication
(10) Pub. No.: US 2007/0047736 A1
(43) Pub. Date: Mar. 1, 2007

(54) Sound signal processing device

(75) Inventor: Tomoki Shioda, Ora-gun (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/505,881

(22) Filed: Aug. 18, 2006

(30) Foreign Application Priority Data
Aug. 24, 2005 (JP) 2005-242180

(51) Int. Cl. H04R 5/00

(52) U.S. Cl. 381/17

(57) ABSTRACT

To simplify the structure of a sound signal processing device for automatically switching between generation of pseudo-surround sound and generation of pseudo-stereo sound based on whether an original sound signal is stereo or monaural. A stereo sound decoder for receiving a sound channel signal of a TV receiving signal determines whether or not the sound type is stereo or monaural based on the presence or absence or the like of a control channel signal, and generates L and R signals according to the result of determination to output to an acoustic process circuit. The result of determination concerning the sound type, which is obtained by the stereo sound decoder is transmitted via a bus to the acoustic process circuit to be utilized in control of the automatic switching by the acoustic process circuit. This can eliminate the need to provide a separate sound type determination circuit.

### CROSS-REFERENCE TO RELATED APPLICATIONS

The priority application number JP2005-242180 upon which this patent application is based is hereby incorporated by reference.

### BACKGROUND OF THE INVENTION

1. Field of the Invention

The present invention relates to a sound signal processing device for generating pseudo-surround sound and pseudo-stereo sound based respectively on a stereo sound signal and a monaural sound signal, and in particular to automatic switching between pseudo-surround sound and pseudo-stereo sound.

2. Description of the Related Art

FIG. 1 is a block diagram showing a sound signal processing device for automatically switching between generation of pseudo-surround sound and generation of pseudo-stereo sound. This device is mounted to a television (TV) receiver. A stereo sound decoder 2 receives a sound channel signal extracted from a TV receiving signal, and outputs a left sound signal L and a right sound signal R. Generation of pseudo-surround sound or pseudo-stereo sound is achieved by mounting to a TV receiver a semiconductor integrated circuit (IC) 4 which provides the above-described functions. The IC 4 receives as sound signals both of the L/R signals. An acoustic process circuit 6 generates and outputs pseudo-surround sound in response to a stereo sound signal input and pseudo-stereo sound in response to a monaural sound signal input.

Here, determination as for whether an input sound is stereo or monaural is carried out by a sound type determination circuit 8 in IC 4 itself. Specifically, the sound type determination circuit 8 carries out the determination while utilizing phase and/or level difference between the L/R signals input, and switches between generation of pseudo-surround sound by the acoustic process circuit 6 and generation of pseudo-stereo sound by the same, based on the result of the determination.

In a conventional structure, in order to achieve automatic switching of the processing carried out by the acoustic process circuit 6, the sound type determination circuit 8 is indispensable. This leads to a problem of an enlarged size of the IC 4.

Also, where the sound type determination circuit 8 determines as a stereo signal when a difference exists in phase and/or level between the L/R signals, and as a monaural signal when no such a difference exists, as determination as for presence or absence of a difference is likely to be affected by fluctuation due to a noise, the manner of setting a threshold, or the like, a problem is expected that high accuracy in a sound type determination is not always guaranteed.

### SUMMARY OF THE INVENTION

According to one aspect of the present invention, there is provided a sound signal processing device, comprising a sound signal generation circuit for determining which of sound types, namely, stereo or monaural, an input signal corresponds to, selectively generating either of a stereo sound signal and a monaural sound signal using the input signal based on a result of determination to output as an original sound signal; an acoustic process circuit for selectively generating either of pseudo-surround sound and pseudo-stereo sound based on the original sound signal; and a bus for transmitting data within the device. The sound signal generation circuit has an interface section with respect to the bus and outputs the result of determination to the bus. The acoustic process circuit has an interface section with respect to the bus, obtains the result of determination from the sound signal generation circuit via the bus, and switches between generation of the pseudo-surround sound and generation of the pseudo-stereo sound based on the result of determination.

### BRIEF DESCRIPTION OF THE DRAWINGS

FIG. 1 is a block diagram showing a conventional sound signal processing device for outputting either of pseudo-surround sound and pseudo-stereo sound while automatically switching between pseudo-surround sound and pseudo-stereo sound; and

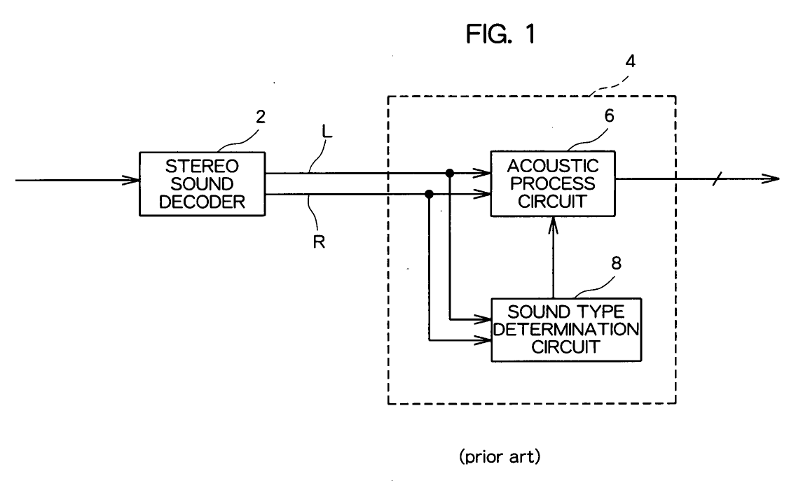

FIG. 2 is a schematic block diagram showing a sound signal processing device according to an embodiment of the present invention, which processes a sound signal of a TV receiving signal to generate and output pseudo-surround sound and pseudo-stereo sound.

### DESCRIPTION OF THE PREFERRED EMBODIMENTS

In the following, an embodiment of the present invention (hereinafter referred to as an embodiment) will be described while referring to the accompanied drawings.

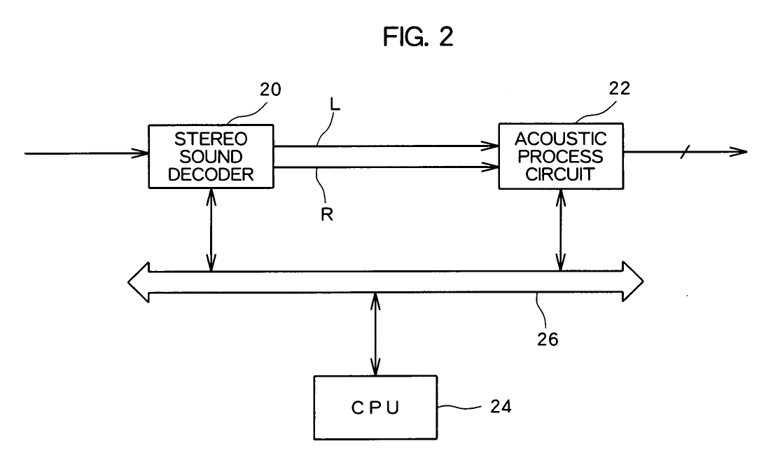

FIG. 2 is a schematic block diagram showing a sound signal processing device according to this embodiment. This sound signal processing device is a device for processing a sound signal of a TV receiving signal, and generates and outputs pseudo-surround sound and pseudo-stereo sound. This device is constructed comprising a stereo sound decoder 20, an acoustic process circuit 22, a CPU 24, and a bus 26, and mounted to a TV receiver, for example.

For example, in a TV signal according to the NTSC system, a baseband of sound band (a main channel), a sub-channel set in a band higher than the main channel, and a control channel are contained. In stereo broadcasting, a sum signal “L+R” and a difference signal “L−R” are transmitted through the main channel and the sub-channel, respectively. In monaural broadcasting, on the other hand, a signal for the main channel alone is transmitted.

It should be noted that besides the above, the sound type may include sound-multiplex broadcasting which is utilized to achieve bilingual broadcasting or the like. In sound-multiplex broadcasting, different monaural sounds are transmitted through the main and sub-channels, respectively.

These sound types can be discriminated by referring to a control channel signal. Specifically, with respect to monaural broadcasting, a control channel signal is not inserted, while, with respect to stereo and sound-multiplex broadcasting, a control channel signal is inserted. The control channel signals for stereo broadcasting and sound-multiplex broadcasting are respectively control subcarrier waves modulated the amplitude by modulating waves having different frequencies. Based on this difference, the respective sound types can be automatically identified.

It is assumed here that, in connection with acoustic effect processing to be described later, the sound type is classified into two, namely, stereo and monaural, in which the monaural sound in the following description includes sound-multiplex broadcasting.

The stereo sound decoder 20 receives a sound channel signal extracted from a TV receiving signal, and determines based on the above-described control channel signal, whether or not the sound type thereof is stereo or monaural (monaural broadcasting and sound-multiplex broadcasting). When it is determined as stereo, the stereo sound decoder 20 generates an L signal and an R signal using a matrix circuit based on a sum signal “L+R” and a difference signal “L−R”, and outputs via an L output terminal and an R output terminal, respectively. On the other hand, when it is determined as monaural, the identical signals are output via the L and R output terminals.

The stereo sound decoder 20 outputs also the result of determination concerning the sound type to the bus 26. The bus 26, which is formed using an I2C bus, for example, enables data exchange by connecting a plurality of devices using two signals, namely, a serial clock and serial data, and operates in synchronism with a clock supplied from a master. In this device, the CPU 24 functions as a master, while the stereo sound decoder 20 and the acoustic process circuit 22 function as slaves. The TV receiver is equipped with a microcomputer for tuner control or the like, and a CPU incorporated in the microcomputer can be used as the CPU 24.

The stereo sound decoder 20 has a bus interface, and writes the result of determination concerning the sound type into the buffer of the interface. The CPU 24 reads the result of determination written in the buffer of the stereo sound decoder 20, and outputs to the bus 26 with designation of the bus address of the acoustic process circuit 22.

The acoustic process circuit 22 also has a bus interface, and obtains the result of determination from the bus 26, which is sent through the bus 26 with designation of the address of its own acoustic process circuit 22.

The acoustic process circuit 22 receives the L and R signals output from the stereo sound decoder 20, and carries out acoustic effect processing according to the result of determination obtained from the bus 26. When the obtained result of determination indicates stereo, the acoustic process circuit 22 generates pseudo-surround sound based on the L and R signals input. On the other hand, when the obtained result of determination indicates monaural, the acoustic process circuit 22 generates pseudo-stereo sound based on the L and R signals input.

As described above, the acoustic process circuit 22 automatically switches between generation of pseudo-surround sound and generation of pseudo-stereo sound based on the result of determination sent via the bus 26 from the stereo sound decoder 20. The acoustic process circuit 22 outputs the generated pseudo-surround sound or pseudo-stereo sound.

The stereo sound decoder 20 to generate L and R outputs based on the sound channel signal and to output is conventionally mounted to the TV receiver for stereo, and a result of determination concerning the sound type, which is obtained by the stereo sound decoder 20 is utilized in the present invention to achieve automatic switching by the acoustic process circuit 22 between generation of pseudo-surround sound and generation of pseudo-stereo sound.

With this structure, the acoustic process circuit 22 need not possess a sound type determination function. This enables simplification and size reduction of the circuit structure of the acoustic process circuit 22.

In this device, the stereo sound decoder 20 and the acoustic process circuit 22 can be constructed as separate ICs 30, 32, and a bus 26 according to a predetermined standard is utilized for transmission of the result of determination concerning the sound type between the IC 30 and the IC 32. This structure can facilitate use of a common acoustic process circuit 22 by TV receivers employing different stereo sound decoders, to obtain pseudo-surround sound and pseudo-stereo sound.

For example, although a TV receiver according to the NTSC system is described in the above, a TV receiver according to any other system such as the PAL system may also employ a common acoustic process circuit 22. In such a case, the stereo sound decoder 20 is substituted by a decoder adapted to processing according to that TV system and having a bus interface having specifications common with those of the bus interface of the stereo sound decoder 20.

Also, determination as for a sound type by the stereo sound decoder 20 is made, for example, in the above-described example of the NTSC system, based on the presence or absence of a control channel signal or the amplitude modulation frequency thereof. That is, as described above, determination concerning a sound type by the stereo sound decoder 20 is made according to the specifications and standard of a signal which defines the sound type according to the respective TV systems. Therefore, accurate determination can be ensured, and reliability in automatic switching by the acoustic process circuit 22 can be improved.

The present invention is applicable not only to a TV receiver but also to any other acoustic/video devices. For example, the present invention can be applied to a video recording and reproduction device having a built-in TV tuner, an FM radio receiver, or the like. These devices may employ an acoustic process circuit 22 common with the one employed by the TV receiver.

Alternatively, in order to achieve automatic switching by the acoustic process circuit 22 based on externally supplied L and R signals, an arrangement is also applicable in which a circuit for determining a sound type based on the L and R signals is separately mounted upon necessity. Also in this case, it is arranged such that the result of determination obtained by the determination circuit is sent via the bus 26 to the acoustic process circuit 22. That is, expansion of the structure so as to include an additional determination circuit can be readily realized without the need to modify the acoustic process circuit 22.

As described above while referring to FIG. 2, the sound signal processing device according to the present invention comprises a sound signal generation circuit for determining which of the sound types, namely, stereo or monaural, an input signal corresponds to, selectively generating either of a stereo sound signal and a monaural sound signal using the input signal based on a result of determination to output as an original sound signal; an acoustic process circuit for selectively generating either of pseudo-surround sound and pseudo-stereo sound based on the original sound signal; and a bus for transmitting data within the device. The sound signal generation circuit has an interface section with respect to the bus and outputs the result of determination to the bus. The acoustic process circuit has an interface section with respect to the bus, obtains the result of determination from the sound signal generation circuit via the bus, and switches between generation of the pseudo-surround sound and generation of the pseudo-stereo sound based on the result of determination.

The sound signal generation circuit is a circuit, similar to the stereo sound decoder 20 as described above, for receiving as the input signal a sound channel signal of a television receiving signal, determining that the sound type is stereo based on a control channel signal contained in the sound channel signal, and outputting as the original sound signals a left(L) sound signal and a right (R) sound signal.

The sound signal generation circuit and the acoustic process circuit are formed as separate integrated circuits.

According to the present invention, the sound type which is determined by the sound signal generation circuit is utilized in switching between generation of pseudo-surround sound by the acoustic process circuit and generation of pseudo-stereo sound by the same. This allows elimination of the need to provide a separate sound type determination circuit, and therefore enables size reduction of the device.

In the above, transmission of the result of determination from the sound signal generation circuit to the acoustic process circuit is carried out via a bus according to predetermined specifications. Therefore, a common acoustic process circuit can be used with the sound signal generation circuits of the TV sets or the like which employ different manners of sound type determination as long as the specifications of the acoustic process circuit are in conformity with those of the bus.

Also, the sound type determination carried out by the sound signal generation circuit is based on the signal properties and characteristics of the input signal, which define the sound type, that is, stereo or monaural, in which a stereo sound signal and a monaural sound signal is generated based on the input signal, preferable accuracy can be ensured with the determination.

What is claimed is:

1. A sound signal processing device, comprising:
a sound signal generation circuit for determining which of sound types, namely, stereoormonaural, an input signal corresponds to, selectively generating either of a stereo sound signal and a monaural sound signal using the input signal based on a result of determination to output as an original sound signal;
an acoustic process circuit for selectively generating either of pseudo-surround sound and pseudo-stereo sound based on the original sound signal; and
a bus for transmitting data within the device,
wherein
the sound signal generation circuit has an interface section with respect to the bus and outputs the result of determination to the bus, and
the acoustic process circuit has an interface section with respect to the bus, obtains the result of determination from the sound signal generation circuit via the bus, and switches between generation of the pseudo-surround sound and generation of the pseudo-stereo sound based on the result of determination.

2. The sound signal processing device according to claim 1, wherein the sound signal generation circuit is a stereo decoder for receiving as the input signal a sound channel signal of a television receiving signal, determining that the sound type is stereo based on a control channel signal contained in the sound channel signal, and outputting as the original sound signals a left sound signal and a right sound signal.

3. The sound signal processing device according to claim 1, wherein the sound signal generation circuit and the acoustic process circuit are formed as separate integrated circuits.
